(19) United States
(12) Patent Application Publication
(10) Pub. No.: US 2026/0129135 A1
(43) Pub. Date: May 7, 2026

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: KAZUKI KADO, Kanagawa (JP)

(21) Appl. No.: 19/373,356

(22) Filed: Oct. 29, 2025

(30) Foreign Application Priority Data
Nov. 7, 2024 (JP) 2024-195414

(51) Int. Cl. H04N 1/23

(52) U.S. Cl. CPC H04N 1/2338; H04N 1/2392; H04N 2201/0094

(57) ABSTRACT

An image forming apparatus controls an output position of printed output sheets to be shifted or rotated every time output sheets corresponding to a specified number of copy sets to be shifted are printed in a case where a shift function or a rotation function for every specified number of sheets to be cut or every specified cutting thickness is set, the shift function or the rotation function for every specified number of copy sets to be shifted is set, and the specified number of sheets to be cut or a specified cutting thickness is not greater than the number of sheets corresponding to the specified number of copy sets to be shifted or a thickness corresponding to the specified number of copy sets to be shifted, respectively.

### BACKGROUND

### Field of the Technology

The present disclosure relates to an image forming apparatus, a method for controlling the image forming apparatus, and a storage medium.

### Description of the Related Art

There is a known function of printing sheets with a sheet output position shifted every desired number of copy sets in the related art.

Further, a technique is known for combining and printing documents so that, on the assumption that a user cuts a printed product after printing, N sets of copies in the page order from page one to page D are created, with one bundle of cut sheets stacked under the other bundle of cut sheets by shifting the printed sheet(s) every number of sheets that can be cut by a cutter, (Japanese Patent Laid-Open No. 2002-281278).

In addition, a technique is known for shifting an output product at a specified stackable height of bundles of sheets by a specified stacking method in order to perform post-processing, such as boxing (Japanese Patent Laid-Open No. 2007-50691).

In the related art, a function of shifting an output position when a desired number of copy sets is printed and a function of shifting based on other factors cannot be specified together. For example, for cutting output sheets by a cutter or the like in post-processing, the maximum number of sheets that can be cut is often limited. For this reason, when a user cuts printed sheets after printing, it is necessary to separate the printed sheets every maximum number of sheets that can be cut, which requires time and effort for the user to do the task.

### SUMMARY

The present disclosure is directed to reducing time and effort for a user to separate printed sheets every desired number of sheets after printing.

According to an aspect of the present disclosure, an image forming apparatus includes at least one memory storing instructions, and at least one processor that, upon execution of the stored instructions, configures the at least one processor to operate as, a first control unit configured to control an output position of printed output sheets to be shifted or rotated every time output sheets corresponding to a specified number of sheets to be cut or a specified cutting thickness are printed in a case where a shift function or a rotation function for every specified number of sheets to be cut or every specified cutting thickness is set and a shift function or a rotation function for every specified number of copy sets to be shifted is not set, a second control unit configured to control an output position of printed output sheets to be shifted or rotated every time output sheets corresponding to a specified number of copy sets to be shifted are printed in a case where the shift function or the rotation function for every specified number of copy sets to be shifted is set and the shift function or the rotation function for every specified number of sheets to be cut or every specified cutting thickness is not set, a third control unit configured to control an output position of printed output sheets to be shifted or rotated every time output sheets corresponding to the specified number of sheets to be cut or the specified cutting thickness are printed or every time output sheets corresponding to the specified number of copy sets to be shifted are printed in a case where the shift function or the rotation function for every specified number of sheets to be cut or every specified cutting thickness is set, the shift function and the rotation function for every specified number of copy sets to be shifted is set, and the specified number of sheets to be cut or the specified cutting thickness is greater than the number of sheets corresponding to the specified number of copy sets to be shifted or a thickness corresponding to the specified number of copy sets to be shifted, respectively, a fourth control unit configured to control an output position of printed output sheets to be shifted or rotated every time output sheets corresponding to the specified number of copy sets to be shifted are printed in a case where the shift function or the rotation function for every specified number of sheets to be cut or every specified cutting thickness is set, the shift function or the rotation function for every specified number of copy sets to be shifted is set, and the specified number of sheets to be cut or the specified cutting thickness is not greater than the number of sheets corresponding to the specified number of copy sets to be shifted or the thickness corresponding to the specified number of copy sets to be shifted, respectively, and a fifth control unit configured to control an output sheet to be printed without shifting or rotating an output position of the printed output sheets in a case where neither the shift function or the rotation function for every specified number of sheets to be cut or every specified cutting thickness nor the shift function or the rotation function for every specified number of copy sets to be shifted is set.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration example of an image forming system.

FIG. 2 is a block diagram illustrating a configuration example of an image forming apparatus.

FIG. 3 is an external appearance view of an input device and an output device of the image forming apparatus.

FIG. 4 is a detailed diagram illustrating an operation unit of the image forming apparatus.

FIG. 5 illustrates a display example of the operation unit.

FIG. 6 illustrates an example of a function settings screen.

FIG. 7 illustrates an example of a finishing settings screen.

FIG. 8 is a flowchart illustrating copy finishing processing.

FIG. 9 illustrates an output product upon execution of the copy finishing processing.

FIG. 10 illustrates an output product upon execution of the copy finishing processing.

FIG. 11 illustrates an output product upon execution of the copy finishing processing.

FIG. 12 illustrates an output product upon execution of the copy finishing processing.

FIG. 13 illustrates an output product upon execution of copy finishing processing.

FIG. 14 illustrates an example of a finishing settings screen.

FIG. 15 illustrates an output product upon execution of copy finishing processing.

FIG. 16 illustrates an example of a finishing settings screen on a personal computer.

FIG. 17 illustrates a pull-down menu on the finishing settings screen on the personal computer.

### DESCRIPTION OF THE EMBODIMENTS

An embodiment of the present disclosure will now be described with reference to the drawings. The claims are not limited to configurations described in the embodiment. Some or all of the configurations can be replaced with equivalents as long as a similar effect and an intended effect can be produced.

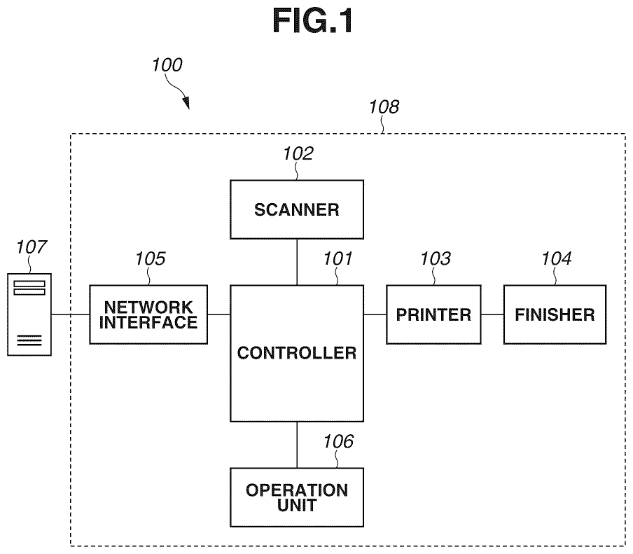

FIG. 1 is a block diagram illustrating a configuration example of an image forming system 100 according to the present embodiment. The image forming system 100 includes a personal computer 107 and an image forming apparatus 108. A configuration of a multi-function peripheral (MFP) is illustrated as an example of the image forming apparatus 108.

The image forming apparatus 108 includes a controller 101, a scanner 102, a printer 103, a finisher 104, a network interface 105, and an operation unit 106.

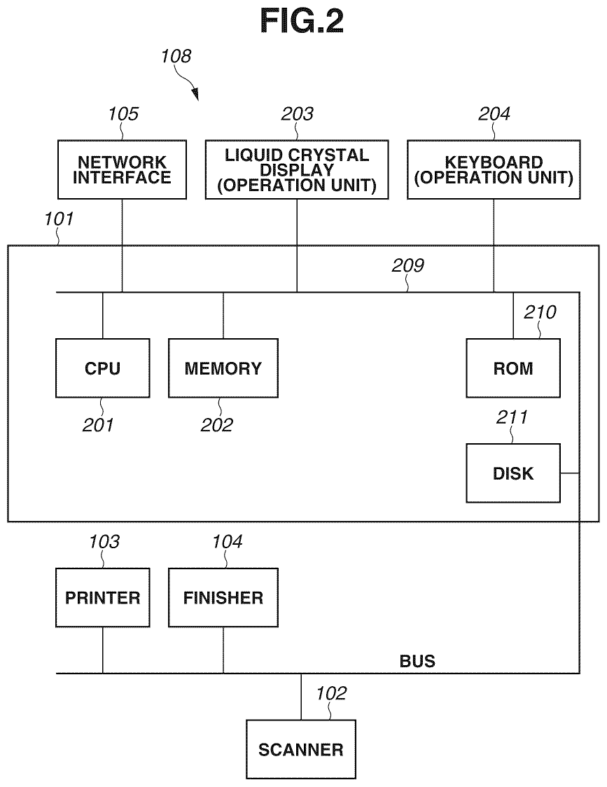

In the configuration example illustrated in FIG. 1, the controller 101 controls the MFP and has a hardware configuration illustrated in FIG. 2.

The scanner 102 is a scanner engine controlled by the controller 101.

The printer 103 is a laser beam printer engine controlled by the controller 101.

The printer 103 connected to the finisher 104 is capable of performing stapling and saddle-stitch processing on a bundle of a plurality of recording media (e.g., sheets of paper) output from the printer 103.

The finisher 104 is also controlled by the controller 101.

The network interface 105 provides the controller 101 with bidirectional communication via the network interface 105, and is connectable to the personal computer 107 via a network.

The operation unit 106 is a user interface and includes a liquid crystal display (LCD) and a keyboard. The operation unit 106 is configured to display information received from the controller 101 and transmit instructions from a user to the controller 101.

All functions can be also used via an interface, such as a network interface.

FIG. 2 is a block diagram illustrating a hardware configuration example of the image forming apparatus 108 illustrated in FIG. 1. The image forming apparatus 108 includes the controller 101, the scanner 102, the printer 103, the finisher 104, the network interface 105, a liquid crystal display 203, and a keyboard 204. The liquid crystal display 203 and the keyboard 204 correspond to the operation unit 106 illustrated in FIG. 1.

The controller 101 includes a central processing unit (CPU) 201, a memory 202, a bus 209, a read-only memory (ROM) 210, and a disk 211.

Inside the controller 101, the CPU 201 is connected to the memory 202, the liquid crystal display 203 and the keyboard 204, both of which are included in the operation unit 106, the ROM 210, and the disk 211 via the bus 209.

Various programs and data are stored in the disk 211 (storage medium), such as a hard disk or a flexible disk, and are sequentially loaded into the memory 202 as appropriate to be executed by the CPU 201. The disk 211 can be detachably attached to the image forming apparatus 108 or can be incorporated in the image forming apparatus 108.

Further, the programs can be configured to be downloaded from another image forming apparatus via a network to be stored in the disk 211.

Examples of the memory 202 include a non-volatile memory, such as a dynamic random access memory (DRAM), and a volatile memory, such as a static RAM (SRAM). The memory 202 may include both the non-volatile memory function and the volatile memory function. Alternatively, the memory 202 may include the volatile memory function, and the disk 211 may include the non-volatile memory function.

Further, the memory 202 can be a detachable memory medium.

The CPU 201 performs display by writing data to the liquid crystal display 203, and inputs instructions from the user by reading data from the keyboard 204 or the liquid crystal display 203 as a touch panel.

Input information is transferred to and accumulated in any one of the memory 202, the disk 211, and the CPU 201 to be used in various types of processing.

The bus 209 is connected to the network interface 105. The CPU 201 reads data from the network interface 105 or writes data into the network interface 105 to perform communication using the network interface 105.

The bus 209 is also connected to the printer 103, the finisher 104, and the scanner 102.

The CPU 201 reads data from and writes data into the printer 103, the finisher 104, and the scanner 102 to perform engine operations, such as printing and scanning, and acquire various statuses.

Image data can be stored in the disk 211 and the memory 202 in the controller 101 from the scanner 102 or the network interface 105.

Image data can be accumulated in the attachable and detachable memory 202 in advance and can be loaded into the memory 202 by attaching the memory 202 to the controller 101.

Image data accumulated in the disk 211 can be moved or copied to the memory 202, and various pieces of layout processing can be performed on the image data in the memory 202 based on instructions from the operation unit 106.

Instead of disposing the printer 103, the finisher 104, and the scanner 102 inside the image forming apparatus 108, the controller 101 in the image forming apparatus 108 may control the printer 103, the finisher 104, and the scanner 102 that exist independently on a network as a single peripheral device.

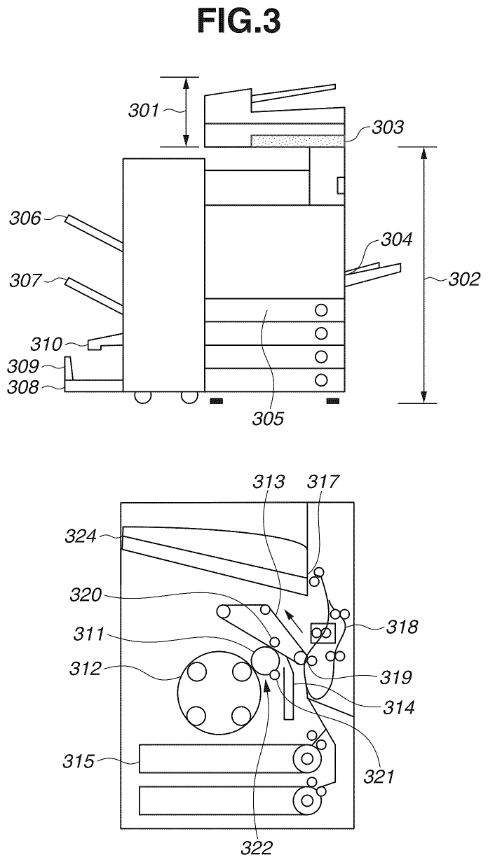

FIG. 3 is an external appearance view of the image forming apparatus 108. A scanner unit 301 serving as an image input device illuminates an image on a sheet as a document and scans using a charge-coupled device (CCD) line sensor to convert the image on the document placed on the scanner into electric image data. Color determination, size determination, and the like are performed based on electrically converted image data.

A printer unit 302 serving as an image output device converts image data into an image on a sheet, and performs folding processing, such as stapling and bookbinding, after the image is printed on the sheet, and then outputs the sheet. A printing operation starts and stops in response to instructions from the CPU 201.

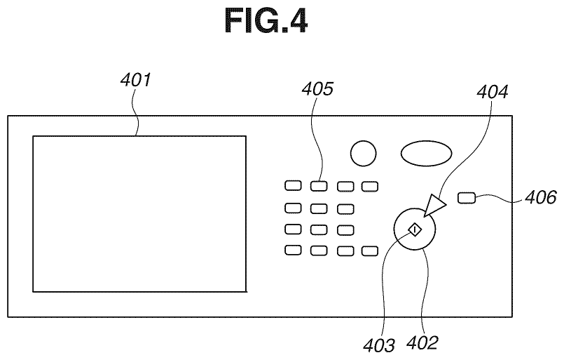

FIG. 4 illustrates a configuration example of an operation unit 303. A touch panel sheet is attached to a liquid crystal panel of a liquid crystal display unit 401, which displays a system operation screen and software keys. When a displayed key is pressed, the positional information is transmitted to the CPU 201.

A start key 402 is used, for example, to start a document image reading operation. A bi-color light-emitting diode (LED) 403 that emits green and red light is disposed at the central portion of the start key 402, and the color of the LED 403 indicates whether the start key 402 is in an operable state. A stop key 404 functions to stop the operation being performed.

A numeric keypad 405 includes a group of numeric and character buttons, and is used to set the number of copy sets and to instruct switching of the screens on the liquid crystal display unit 401. A user mode key 406 is pressed to configure device settings.

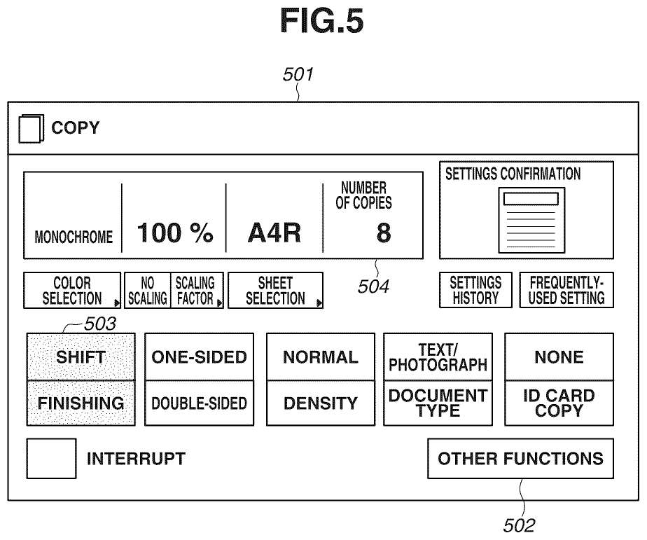

FIG. 5 illustrates an example of the display of the liquid crystal display unit 401. A copy basic screen 501 is an example of the display of the liquid crystal display unit 401. The user can select a cassette to be used and set a magnification on the copy basic screen 501. The number of copy sets 504 can be set by inputting a value using the numeric keypad 405.

A manual feed tray 304 and sheet feed cassettes 305 illustrated in FIG. 3 are portions in which sheets to be printed are placed.

Sheet discharge trays 306 and 307 are portions to which printed sheets are output.

A saddle tray 308 is a portion to which saddle-stitched sheets are output. The saddle tray 308 includes a stopper 309 that prevents a saddle-stitched output product from falling off, and a tray sensor 310 that issues a notification that the saddle tray 308 is full of saddle-stitched output sheets.

The printer unit 302 will now be described in detail. FIG. 3 illustrates an example of the full-color image forming apparatus 108. A photosensitive drum 311 is charged by a primary charger 321 to an electric potential of a specific polarity, and a position 322 indicated by an arrow is exposed to light by a not-illustrated exposure unit. In this manner, an electrostatic latent image corresponding to a first color component is formed. After that, the electrostatic latent image is developed by one of four developing devices 312.

An intermediate transfer belt 313 is driven in an arrow direction. The first color component image formed on the photosensitive drum 311 is transferred to the intermediate transfer belt 313 by electric field formed by a primary transfer roller 320 during passing through a contact portion between the photosensitive drum 311 and the intermediate transfer belt 313.

The surface of the photosensitive drum 311 after the transfer of the image to the intermediate transfer belt 313 is cleaned using a cleaning device 314. This processing is sequentially repeated and images in four colors are superimposed on the intermediate transfer belt 313 to form a full-color image. In the case of forming an image in a single color, the transfer processing is performed only once.

The image transferred to the intermediate transfer belt 313 is printed on a sheet fed from a cassette 315 at the secondary transfer roller 319. The sheet having the image printed thereon is heated and fixed by a fixing device. After the fixation, the sheet passes through a portion 317 and is conveyed to a discharge port 324 to be discharged to the outside of the image forming apparatus 108. In performing double-sided printing, the sheet is circulated through a reverse path 318 and print processing is repeated. When the sheet is discharged to the discharge port 324, stapling processing, shift processing for shifting the sheet output position, and the like are performed depending on the settings.

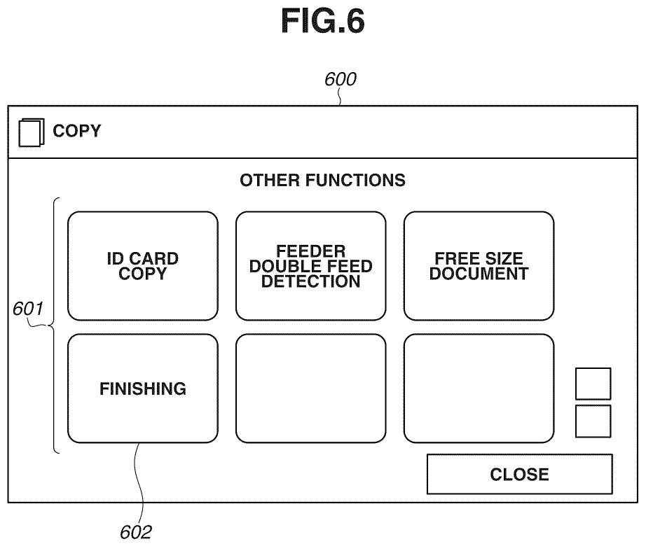

FIG. 6 illustrates a function settings screen to be displayed after an other functions button 502 is pressed on the copy basic screen 501. A function settings screen 600 includes a function button group 601, and advanced function settings can be configured by selecting a function to be set from the function button group 601. The function button group 601 can be disposed on the copy basic screen 501 as a shortcut button.

For example, a finishing setting button 503 can be arranged on the copy basic screen 501 illustrated in FIG. 5 as a shortcut button 602.

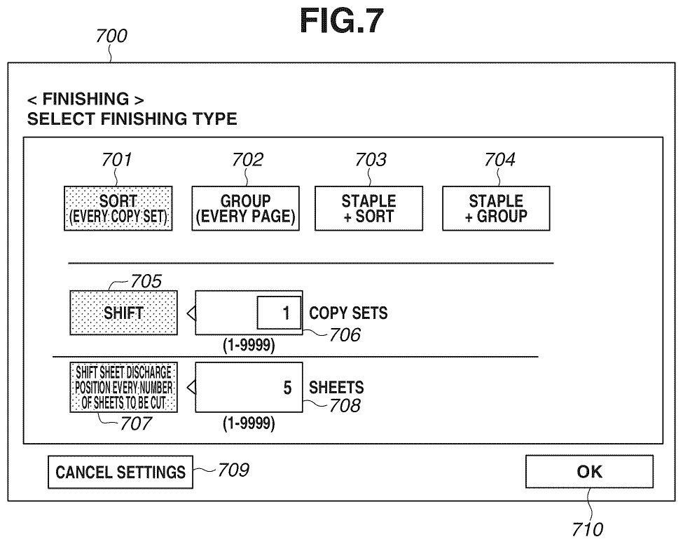

FIG. 7 illustrates an example of a finishing type setting screen to be displayed upon the finishing setting button 503 illustrated in FIG. 5 being pressed. On a finishing settings screen 700, sheet processing, including stapling, folding, and shifting, can be set. Pressing the finishing setting button 503 causes the color of the finishing setting button 503 to be changed, bringing the finishing setting button 503 into a selected state. When an OK button 710 is pressed in this state, sheet processing can be set. Pressing a cancel settings button 709 can cancel the current settings.

A sort button 701 is used for setting of sorting pages in order for each copy set. A group button 702 is used for setting of grouping the same pages together across copy sets. A “staple+sort” button 703 is used for setting for stapling processing in addition to sorting processing. A “staple +group” button 704 is used for setting for stapling processing in addition to grouping processing. The buttons 701 to 704 are mutually exclusive and cannot be set simultaneously.

A shift button 705 is used for setting of shifting for each copy set. A shift can be performed on each copy set with a numerical value entered in a number-of-copy-sets-to-be-shifted input area 706.

A shift-every-number-of-sheets-to-be-cut button 707 is used for setting of shifting every desired number of sheets to be cut. A shift can be performed on every specified number of sheets by inputting a numerical value into a number-of-sheets-to-be-cut input area 708. The shift-every-number-of-sheets-to-be-cut button 707 can be used when the sort button 701 or the group button 702 is set. Any number of sheets can be specified as the number of sheets to be cut, and thus a term, such as “shift every desired number of sheets” can be used for the shift-every-number-of-sheets-to-be-cut button 707. The number of sheets to be cut is not limited only to a desired number of sheets, but instead, a cutting thickness may be specified. The cutting thickness refers to the thickness of a sheet bundle.

In this case, for example, the thickness of a sheet bundle of output sheets is calculated based on the number of output sheets and the grammage of sheets, and a shift is performed every set cutting thickness.

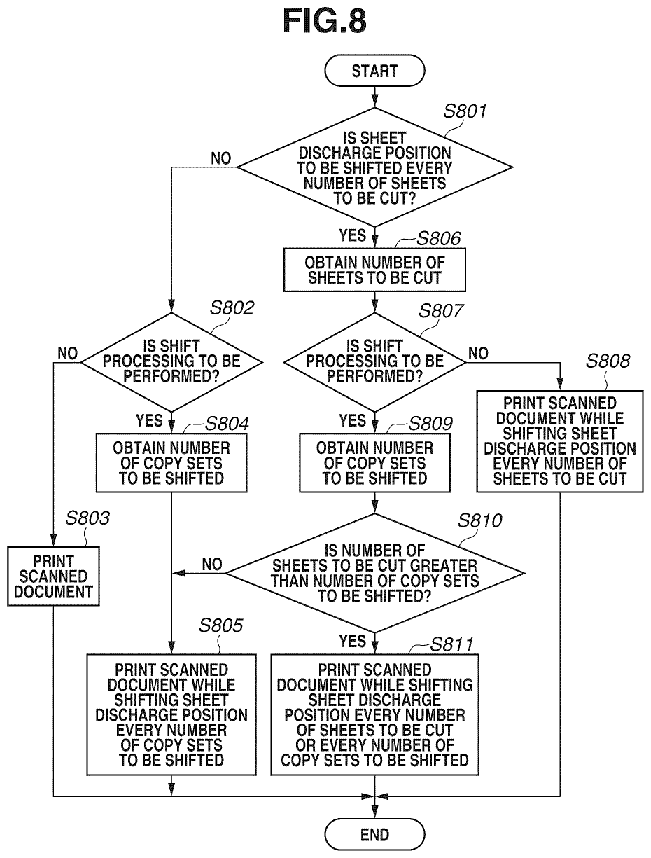

FIG. 8 is a flowchart illustrating copy finishing processing. Settings are configured on the finishing settings screen 700 illustrated in FIG. 7, and the start key 402 illustrated in FIG. 4 is pressed to start the processing illustrated in FIG. 8. A control method for the image forming apparatus 108 will now be described.

On the finishing settings screen 700 illustrated in FIG. 7, the CPU 201 sets a shift function for every number of sheets to be cut specified on the number-of-sheets-to-be-cut input area 708 by selecting the shift-every-number-of-sheets-to-be-cut button 707. Further, the CPU 201 sets the shift function for every number of copy sets to be shifted specified on the number-of-copy-sets-to-be-shifted input area 706 by selecting the shift button 705.

In step S801, the CPU 201 determines whether a shift is to be performed for the number of sheets to be cut. If the shift-every-number-of-sheets-to-be-cut button 707 illustrated in FIG. 7 is selected, the CPU 201 determines that a shift is to be performed for the number of sheets to be cut. The shift-every-number-of-sheets-to-be-cut button 707 is used to set the shift function for every number of sheets to be cut specified on the number-of-sheets-to-be-cut input area 708. If it is determined that a shift is to be performed for the number of sheets to be cut (NO in step S801), the processing proceeds to step S802. If it is determined a shift is to be performed for the number of sheets to be cut (YES in step S801), the processing proceeds to step S806.

In step S802, the CPU 201 determines whether a shift is to be performed for the number of copy sets. If the shift button 705 illustrated in FIG. 7 is selected, the CPU 201 determines that a shift is to be performed. The shift button 705 is used for setting a shift function for every number of copy sets specified on the number-of-copy-sets-to-be-shifted input area 706. If it is determined that a shift is not to be performed (NO in step S802), the processing proceeds to step S803. If it is determined that the shift is to be performed (YES in step S802), the processing proceeds to step S804.

In step S803, the CPU 201 controls the printer 103 to print a document scanned by the scanner 102, and then the processing of the flowchart ends. Specifically, the CPU 201 controls the printer 103 to print an output sheet without shifting the output position of the printed output sheet using the finisher 104, and then the processing of the flowchart ends.

In step S804, the CPU 201 acquires a value input in the number-of-copy-sets-to-be-shifted input area 706 illustrated in FIG. 7 as the number of copy sets to be shifted.

In step S805, the CPU 201 controls the printer to print the document scanned by the scanner 102 while shifting the sheet output position every number of copy sets, which is acquired in step S804. The processing of the flowchart then ends. Specifically, the CPU 201 controls the finisher 104 to shift the output position of the printed output sheets every time printing is performed by the printer 103 on the output sheets corresponding to the number of copy sets to be shifted acquired in step S804, and then the processing of the flowchart ends.

In step S806, the CPU 201 acquires a numerical value input in the number-of-sheets-to-be-cut input area 708 illustrated in FIG. 7 as the number of sheets to be cut.

In step S807, the CPU 201 determines whether a shift is to be performed for the number of copy sets. If the shift button 705 illustrated in FIG. 7 is set, the CPU 201 determines that a shift is to be performed. If it is determined that a shift is not to be performed (NO in step S807), the processing proceeds to step S808. If it is determined that a shift is to be performed (YES in step S807), the processing proceeds to step S809.

In step S808, the CPU 201 controls the printer 103 to print the document scanned by the scanner 102 while shifting the sheet output position every number of sheets to be cut, which is acquired in step S806. The processing of the flowchart then ends. Specifically, the CPU 201 controls the finisher 104 to shift the output position of the printed output sheet every time printing is performed by the printer 103 on the output sheets corresponding to the number of sheets to be cut acquired in step S806, and then the processing of the flowchart ends.

In step S809, the CPU 201 acquired a value input in the number-of-copy-sets-to-be-shifted input area 706 illustrated in FIG. 7 as the number of copy sets to be shifted.

In step S810, the CPU 201 determines whether the number of sheets to be cut is greater than the number of sheets corresponding to the number of copy sets to be shifted. For example, in a case where the number of copy sets to be shifted is one for an output product including four pages for each copy set (4 pages/copy set), the number of sheets corresponding to the number of copy sets to be shifted is four. In a case where the number of copy sets to be shifted is five, the number of sheets corresponding to the number of copy sets to be shifted is twenty. If it is determined that the number of sheets to be cut is not greater than the number of sheets corresponding to the number of copy sets to be shifted (YES in step S810), the processing proceeds to step S805. If it is determined that number of sheets to be cut is greater than the number of sheets corresponding to the number of copy sets to be shifted (NO in step S810), the processing proceeds to step S811.

In step S805, the CPU 201 controls the printer 103 to print the document scanned by the scanner 102 while shifting the sheet output position every number of copy sets to be shifted. The number of copy sets to be shifted is acquired in step S804. Then, the processing of the flowchart ends.

In step S811, the CPU 201 controls the document scanned by the scanner 102 to be printed by the printer 103 while shifting the sheet output position every number of sheets to be cut, which is acquired in step S806, or every number of copy sets to be shifted, which is obtained in step S804. The processing of the flowchart then ends. Specifically, the CPU 201 controls the finisher 104 to shift the output position of the printed output sheets every time printing is performed by the printer 103 on the output sheets corresponding to the number of sheets to be cut, which is acquired in step S806, or on the output sheets corresponding to the number of copy sets to be shifted, which is acquired in step S804, and then the processing of the flowchart ends.

In the processing illustrated in FIG. 8, a cutting thickness as described above can be used instead of the number of sheets to be cut.

Specific examples of copy finishing processing and an output product described above with reference to FIG. 8 will now be described.

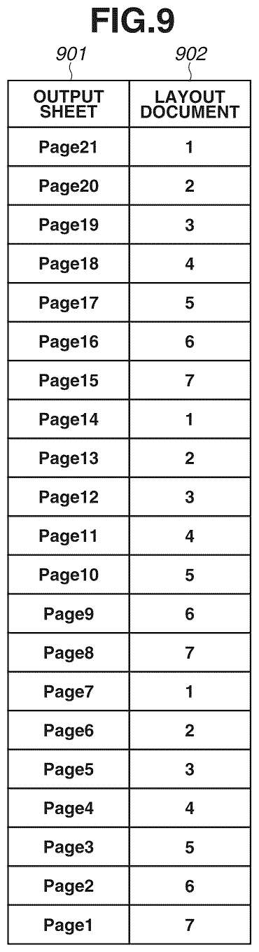

FIGS. 9, 10, 11, and 12 each illustrate an image of an output product when three sets of an output product including 7 pages for each copy set (7 pages/copy set) are printed.

FIG. 9 illustrates an image of an output product when the shift button 705 and the shift-every-number-of-sheets-to-be-cut button 707 illustrated in FIG. 7 are not set, i.e., an image of the output product acquired in step S803. An output sheet 901 shows a page number of each output sheet, and a layout document 902 indicates a page number of a document to be allocated to the corresponding output sheet to be output. Printing is sequentially performed so that pages seven to one of the document are printed on the output sheets one to seven, respectively, as the first copy set, and then the output sheet eight and subsequent output sheets are printed as the second copy set.

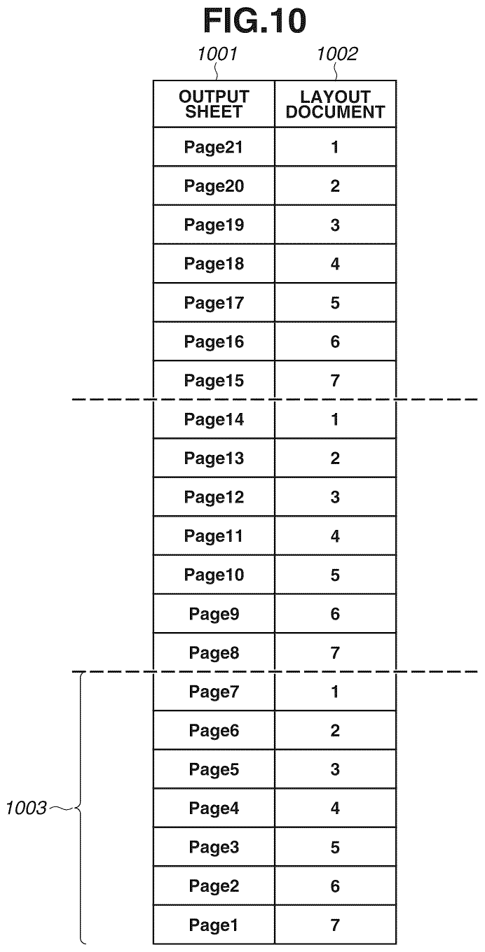

FIG. 10 illustrates an image of an output product when the shift button 705 illustrated in FIG. 7 is set and the shift-every-number-of-sheets-to-be-cut button 707 is not set, i.e., an image of the output product acquired in step S805. It is on the assumption that one is input as a value in the number-of-copy-sets-to-be-shifted input area 706. An output sheet 1001 shows a page number of each output sheet, and a layout document 1002 shows a page number of a document to be allocated to the corresponding output sheet to be output. Pages seven to one (1003) of the document are printed on the output sheets one to seven, respectively, as the first copy set, and then a shift is performed. The output sheet eight and subsequent sheets are sequentially printed as the second copy set. Printing is performed by the printer 103 on every number of copy sets to be shifted, and thus a shift is performed when the output sheets seven and fourteen are printed.

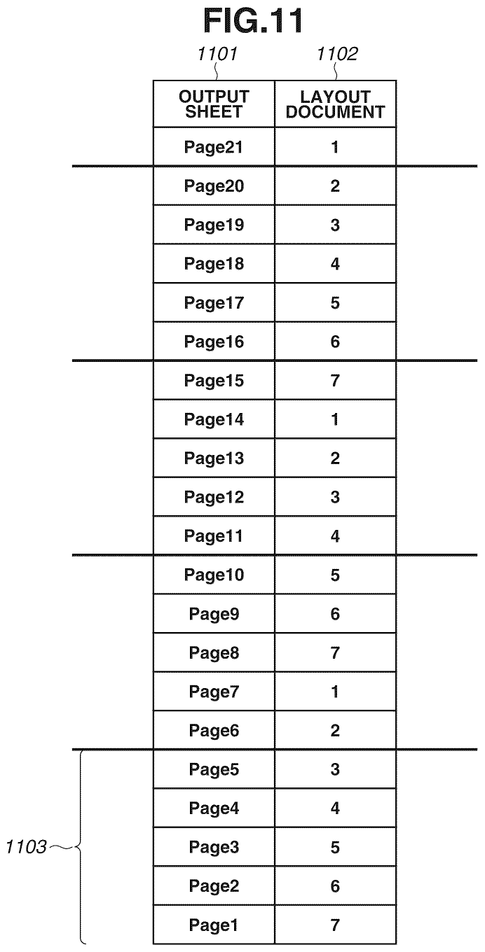

FIG. 11 illustrates an image of an output product when the shift button 705 illustrated in FIG. 7 is not set and the shift-every-number-of-sheets-to-be-cut button 707 is set, i.e., an image of the output product acquired in step S808. It is on the assumption that five is input as a value in the number-of-sheets-to-be-cut input area 708. An output sheet 1101 shows a page number of each output sheet, and a layout document 1102 shows a page number of a document to be allocated to the corresponding output sheet to be output. Pages seven to three (1103) of the document are printed on the output sheets one to five, respectively, and then a shift is performed. The output sheet six and subsequent output sheets are sequentially printed. Printing is performed by the printer 103 on every number of sheets to be cut, and thus, a shift is performed when each of the output sheets five, ten, fifteen, and twenty is printed.

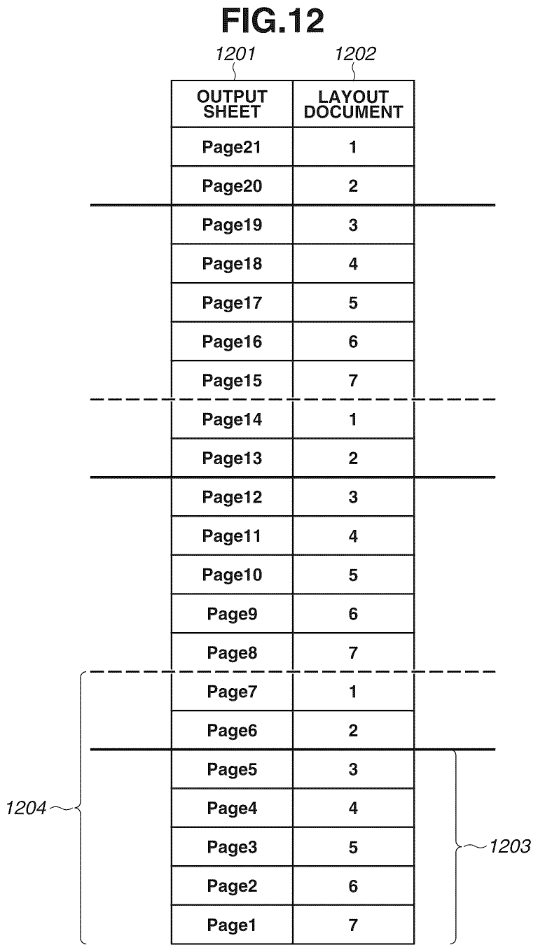

FIG. 12 illustrates an image of an output product when the shift button 705 and the shift-every-number-of-sheets-to-be-cut button 707 illustrated in FIG. 7 are set, i.e., an image of the output product acquired in step S811. It is on the assumption that one is input as a value in the number-of-copy-sets-to-be-shifted input area 706, and five is input as a value in the number-of-sheets-to-be-cut input area 708. An output sheet 1201 shows a page number of each output sheet, and a layout document 1202 shows a page number of a document to be allocated to the corresponding output sheet to be output. Pages seven to three (1203) of the document are printed on the output sheets one to five, respectively, and then a shift is performed. Pages two and one of the document are printed on the output sheets six and seven, respectively, and then a shift is performed since one copy set (1204) is printed. Then, page seven of the document is printed on the output sheet eight, and print printing is sequentially performed. Printing is performed on every five sheets to be cut and on every one set to be shifted, and thus, a shift is performed when the output sheets five, seven, twelve, fourteen, and nineteen are printed. Among these output sheets, the output sheets five, twelve, and nineteen each correspond to a shift timing for the number of sheets to be cut, and the output sheets seven and fourteen each correspond to a shift timing for the number of copy sets.

According to the above-described embodiment, a copy function can be carried out with the limitation on the number of sheets to be cut in the post processing taken into account. For example, in the specific example illustrated in FIG. 12, after the output sheets one to five are cut, the output sheets six and seven are cut. A sheet bundle of the output sheets one to five and a sheet bundle of the output sheets six and seven are then stacked, enabling the user to obtain a desired printed product per copy set without time and effort required to separate the printed sheets every number of sheets to be cut.

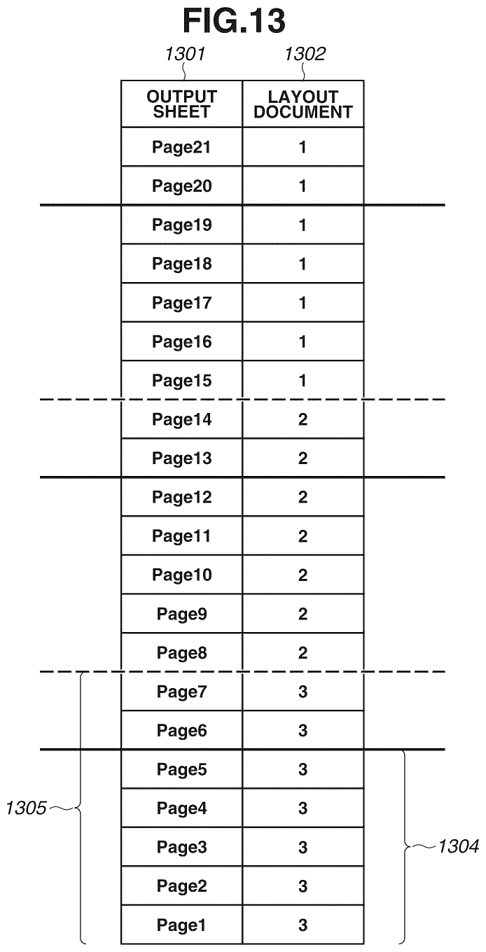

The shift button 705 and the shift-every-number-of-sheets-to-be-cut button 707 can be combined both with the sort button 701 and with the group button 702. An image of the output product acquired in step S811 when the group button 702 and the shift-every-number-of-sheets-to-be-cut button 707 are selected will be described with reference to FIG. 13. When the group button 702 is selected, the output position is shifted every page of a document. Thus, the number of copy sets to be shifted in the flowchart illustrated in FIG. 8 is one copy set. FIG. 13 illustrates an image of an output product when seven copy sets of the output product including three pages per copy set (3 pages/copy set) are printed. It is on the assumption that five is input as a value in the number-of-sheets-to-be-cut input area 708. An output sheet 1301 shows a page number of each output sheet, and a layout document 1302 shows a page number of a document to be allocated to the corresponding output sheet to be output. Initially, page three of the document is printed on the output sheets one to five (1203) since the number of sheets to be cut is five, and then a shift is performed. Then, page three of the document is printed on the output sheets six and seven, and a shift is performed using the group function (1204). Page two of the document is printed on the output sheet eight, and printing is sequentially performed. Printing is performed on every five sheets to be cut and on every page of the document, and thus, a shift is performed when the output sheets five, seven, twelve, fourteen, and nineteen are printed. Among these output sheets, the output sheets five, twelve, and nineteen each correspond to a shift timing for the number of sheets to be cut, and the output sheets seven and fourteen each correspond to a group shift timing. In the specific example illustrated in FIG. 13, the output sheets one to five are cut, and then the output sheets six and seven are cut. A sheet bundle of the output sheets one to five and a sheet bundle of the output sheets six and seven are stacked, enabling the user to obtain a desired printed product without time and effort required to separate the printed sheets every number of sheets to be cut.

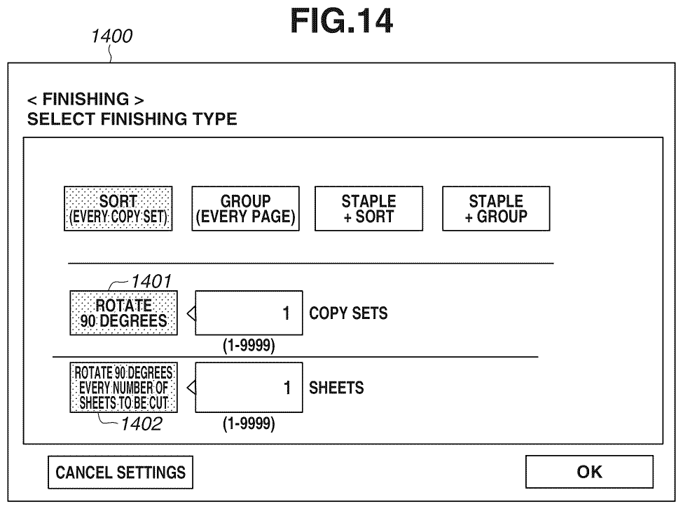

A shift for shifting a sheet output position based on the shift button 705 and the shift-every-number-of-sheets-to-be-cut button 707 can be a function of rotating an output orientation by 90 degrees. Rotating an output orientation is performed by the printer 103 while sheets are discharged to the discharge port 324. FIG. 14 illustrates a screen 1400 as a finishing settings screen when the function of rotating an output orientation by 90 degrees is used instead of shifting. Terms, such as a 90-degree rotation button 1401 and a “90-degree rotation for every number of sheets to be cut” button 1402 can be used for the shift button 705 and the shift-every-number-of-sheets-to-be-cut button 707, respectively. In this case, in steps S805, S808, and S811, the CPU 201 controls an output position of an output sheet to be rotated, instead of shifting the output position of the output sheet.

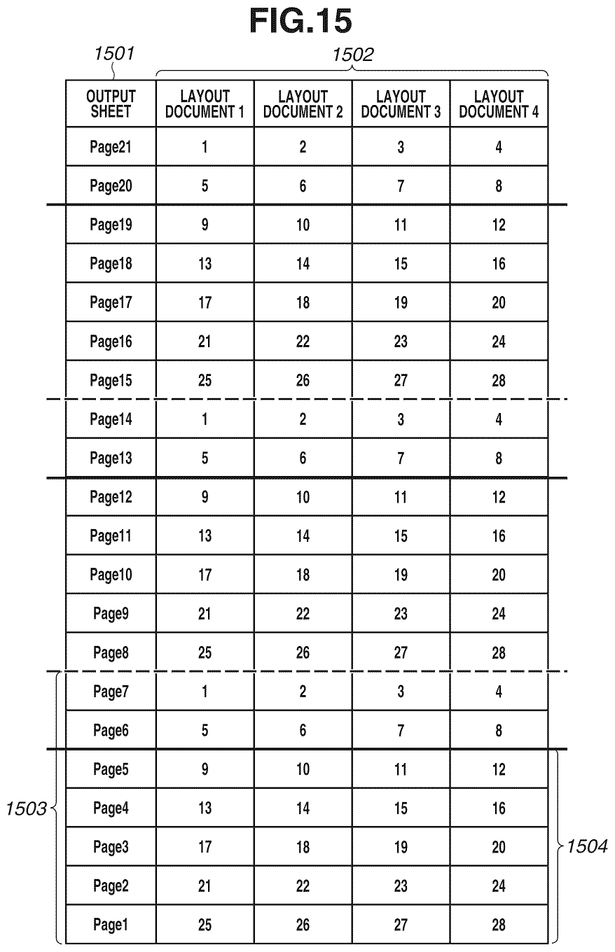

The copy finishing processing described above with reference to FIG. 8 can be combined with any other functions. For example, the copy finishing processing can also be combined with a function of allocating a plurality of documents to print sheets. FIG. 15 illustrates a copy finishing output image in a case where three copy sets of a document including 28 sheets are printed and four sheets are allocated to each page of output sheets. It is on the assumption that one is input as a value for the number-of-copy-sets-to-be-shifted input area 706 and five is input as a value for the number-of-sheets-to-be-cut input area 708. An output sheet 1501 shows a page number of each output sheet, and a layout document 1502 shows a page number of the document to be allocated to the corresponding output sheet to be output. Pages nine to twenty eight of the document are printed on the output sheets one to five (1504), and then a shift is performed. Pages one to eight of the document are printed on the output sheets six and seven, and thus, a shift is performed since one set (1503) is printed. Then, pages nine to twenty eight are printed on the output sheets eight to twelve, and printing is sequentially performed. Printing is performed on every five sheets to be cut and every one set to be shifted, and thus, a shift is performed when the output sheets five, seven, twelve, fourteen, and nineteen are printed. Among these output sheets, the output sheets five, twelve, and nineteen each correspond to a shift timing for the number of sheets to be cut, and the output sheets seven and fourteen each correspond to a shift timing for the number of copy sets.

In the examples illustrated in FIGS. 9 to 13, the CPU 201 controls a document corresponding to one page to be printed on a corresponding page of output sheets. On the other hand, in the example illustrated in FIG. 15, the CPU 201 controls a plurality of pages of a document to be printed on a corresponding page of output sheets.

The copy finishing processing function described above with reference to FIG. 8 can also be used in printing from the personal computer 107 illustrated in FIG. 1. For example, in the flowchart illustrated in FIG. 8, printing can be performed using document data transmitted from the personal computer 107 instead of a document scanned by the scanner 102 in steps S803, S805, S811, and S808.

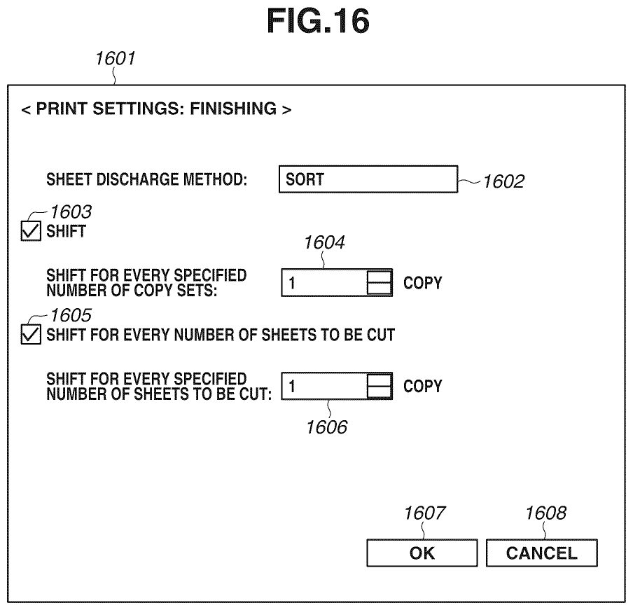

A print settings screen 1601 illustrated in FIG. 16 is a screen for print settings to be configured on the personal computer 107.

The sort button 701, the group button 702, the “staple +sort” button 703, and the “staple+group” button 704 can be set using a finishing setting pull-down menu 1602. The shift button 705 and the shift-every-number-of-sheets-to-be-cut button 707 can be set on a shift setting checkbox 1603 and a shift-every-number-of-sheets-to-be-cut checkbox 1605, respectively. Numerical values for the number-of-copy-sets-to-be-shifted input area 706 and the number-of-sheets-to-be-cut input area 708 can be set by inputting numerical values into input areas 1604 and 1606, respectively. Pressing an OK button 1607 can determine the settings, and pressing a cancel button 1608 can cancel the settings.

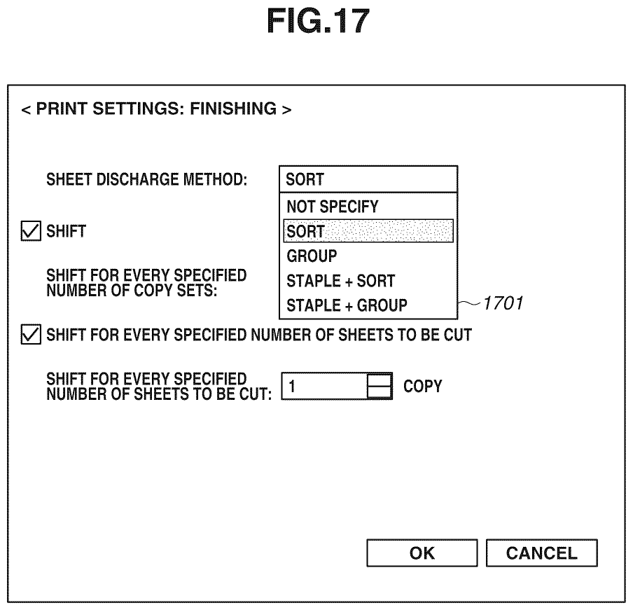

In the finishing setting pull-down menu 1602, selection items 1701 that can be set as illustrated in FIG. 17 are displayed. For example, “no specify, “sort”, “group”, “staple+sort”, and “staple+group” are displayed as the selection items 1701.

The print settings screen 1601 can be displayed not only on the personal computer 107, but also on a mobile terminal and the like. Displaying the print settings screen 1601 and receiving user settings enables shift based on the number of copy sets and a maximum number of sheets to be cut, not only during copying but also during printing when the user cuts the printed product to a desired sheet size after printing.

In this case, in steps S803, S805, S808, and S811 illustrated in FIG. 8, the CPU 201 controls the printer 103 to print the document received from the personal computer 107 or the like on output sheets.

The shift-every-number-of-sheets-to-be-cut button 707 and the number-of-sheets-to-be-cut input area 708 illustrated in FIG. 7 can also be used to set a function of shifting or rotating every specified number of sheets to be cut or every specified cutting thickness as described above.

The shift button 705 and the number-of-copy-sets-to-be-shifted input area 706 illustrated in FIG. 7 can also be used to set a function of shifting for or rotating every specified number of copy sets to be shifted as described above.

As described above, according to the embodiment of the present disclosure, time and effort for a user to separate a printed product every desired number of sheets after printing can be reduced.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-195414, filed Nov. 7, 2024, which is hereby incorporated by reference herein in its entirety.

What is claimed is:

1. An image forming apparatus comprising:
at least one memory storing instructions; and
at least one processor that, upon execution of the stored instructions, configures the at least one processor to operate as:
a first control unit configured to control an output position of printed output sheets to be shifted or rotated every time output sheets corresponding to a specified number of sheets to be cut or a specified cutting thickness are printed in a case where a shift function or a rotation function for every specified number of sheets to be cut or every specified cutting thickness is set and a shift function or a rotation function for every specified number of copy sets to be shifted is not set;
a second control unit configured to control an output position of printed output sheets to be shifted or rotated every time output sheets corresponding to a specified number of copy sets to be shifted are printed in a case where the shift function or the rotation function for every specified number of copy sets to be shifted is set and the shift function or the rotation function for every specified number of sheets to be cut or every specified cutting thickness is not set;
a third control unit configured to control an output position of printed output sheets to be shifted or rotated every time output sheets corresponding to the specified number of sheets to be cut or the specified cutting thickness are printed or every time output sheets corresponding to the specified number of copy sets to be shifted are printed in a case where the shift function or the rotation function for every specified number of sheets to be cut or every specified cutting thickness is set, the shift function and the rotation function for every specified number of copy sets to be shifted is set, and the specified number of sheets to be cut or the specified cutting thickness is greater than the number of sheets corresponding to the specified number of copy sets to be shifted or a thickness corresponding to the specified number of copy sets to be shifted, respectively;
a fourth control unit configured to control an output position of printed output sheets to be shifted or rotated every time output sheets corresponding to the specified number of copy sets to be shifted are printed in a case where the shift function or the rotation function for every specified number of sheets to be cut or every specified cutting thickness is set, the shift function or the rotation function for every specified number of copy sets to be shifted is set, and the specified number of sheets to be cut or the specified cutting thickness is not greater than the number of sheets corresponding to the specified number of copy sets to be shifted or the thickness corresponding to the specified number of copy sets to be shifted, respectively; and
a fifth control unit configured to control an output sheet to be printed without shifting or rotating an output position of the printed output sheets in a case where neither the shift function or the rotation function for every specified number of sheets to be cut or every specified cutting thickness nor the shift function or the rotation function for every specified number of copy sets to be shifted is set.

2. The image forming apparatus according to claim 1,
wherein in a case where the shift function for every specified number of sheets to be cut is set and the shift function for every specified number of copy sets to be shifted is not set, the first control unit is configured to control the output position of the printed output sheets to be shifted every time the output sheets corresponding to the specified number of sheets to be cut are printed,
wherein in a case where the shift function for every specified number of copy sets to be shifted is set and the shift function for every specified number of sheets to be cut is not set, the second control unit is configured to control the output position of the printed output sheets to be shifted every time the output sheets corresponding to the specified number of copy sets to be shifted are printed,
wherein in a case where the shift function for every specified number of sheets to be cut is set, the shift function for every specified number of copy sets to be shifted is set, and the specified number of sheets to be cut is greater than the number of sheets corresponding to the specified number of copy sets to be shifted, the third control unit is configured to control the output position of the printed output sheets to be shifted every time the output sheets corresponding to the specified number of sheets to be cut are printed or every time the output sheets corresponding to the specified number of copy sets to be shifted are printed,
wherein in a case where the shift function for every specified number of sheets to be cut is set, the shift function for every specified number of copy sets to be shifted is set, and the specified number of sheets to be cut is not greater than the number of sheets corresponding to the specified number of copy sets to be shifted, the fourth control unit is configured to control the output position of the printed output sheets to be shifted every time the output sheets corresponding to the specified number of copy sets to be shifted are printed, and
wherein in a case where neither the shift function for every specified number of sheets to be cut nor the shift function for every specified number of copy sets to be shifted is set, the fifth control unit is configured to control the output sheet to be printed without shifting the output position of the printed output sheets.

3. The image forming apparatus according to claim 1,
wherein in a case where the rotation function for every specified number of sheets to be cut is set and the rotation function for every specified number of copy sets to be shifted is not set, the first control unit is configured to control the output position of the printed output sheets to be rotated every time the output sheets corresponding to the specified number of sheets to be cut are printed,
wherein in a case where the rotation function for every specified number of copy sets to be shifted is set and the rotation function for every specified number of sheets to be cut is not set, the second control unit is configured to control the output position of the printed output sheets to be rotated every time the output sheets corresponding to the specified number of copy sets to be shifted are printed,
wherein in a case where the rotation function for every specified number of sheets to be cut is set, the rotation function for every specified number of copy sets to be shifted is set, and the specified number of sheets to be cut is greater than the number of sheets corresponding to the specified number of copy sets to be shifted, the third control unit is configured to control the output position of the printed output sheets to be rotated every time the output sheets corresponding to the specified number of sheets to be cut are printed or every time the output sheets corresponding to the specified number of copy sets to be shifted are printed,
wherein in a case where the rotation function for every specified number of sheets to be cut is set, the rotation function for every specified number of copy sets to be shifted is set, and the specified number of sheets to be cut is not greater than the number of sheets corresponding to the specified number of copy sets to be shifted, the fourth control unit is configured to control the output position of the printed output sheets to be rotated every time the output sheets corresponding to the specified number of copy sets to be shifted are printed, and
wherein in a case where neither the rotation function for every specified number of sheets to be cut nor the rotation function for every specified number of copy sets to be shifted is set, the fifth control unit is configured to control the output sheet to be printed without rotating the output position of the printed output sheets.

4. The image forming apparatus according to claim 1,
wherein in a case where the shift function for every specified cutting thickness is set and the shift function for every specified number of copy sets to be shifted is not set, the first control unit is configured to control the output position of the printed output sheets to be shifted every time the output sheets corresponding to the specified cutting thickness are printed,
wherein in a case where the shift function for every specified number of copy sets to be shifted is set and the shift function for every specified cutting thickness is not set, the second control unit is configured to control the output position of the printed output sheets to be shifted every time the output sheets corresponding to the specified number of copy sets to be shifted are printed,
wherein in a case where the shift function for every specified cutting thickness is set, the shift function for every specified number of copy sets to be shifted is set, and the specified cutting thickness is greater than the thickness corresponding to the specified number of copy sets to be shifted, the third control unit is configured to control the output position of the printed output sheets to be shifted every time the output sheets corresponding to the specified cutting thickness are printed or every time the output sheets corresponding to the specified number of copy sets to be shifted are printed,
wherein in a case where the shift function for every specified cutting thickness is set, the shift function for every specified number of copy sets to be shifted is set, and the specified cutting thickness is not greater than the thickness corresponding to the specified number of copy sets to be shifted, the fourth control unit is configured to control the output position of the printed output sheets to be shifted every time the output sheets corresponding to the specified number of copy sets to be shifted are printed, and
wherein in a case where neither the shift function for every specified cutting thickness nor the shift function for every specified number of copy sets to be shifted is set, the fifth control unit is configured to control the output sheet to be printed without shifting the output position of the printed output sheets.

5. The image forming apparatus according to claim 1,
wherein in a case where the rotation function for every specified cutting thickness is set and the rotation function for every specified number of copy sets to be shifted is not set, the first control unit is configured to control the output position of the printed output sheets to be rotated every time the output sheets corresponding to the specified cutting thickness are printed,
wherein in a case where the rotation function for every specified number of copy sets to be shifted is set and the rotation function for every specified cutting thickness is not set, the second control unit is configured to control the output position of the printed output sheets to be rotated every time the output sheets corresponding to the specified number of copy sets to be shifted are printed,
wherein in a case where the rotation function for every specified cutting thickness is set, the rotation function for every specified number of copy sets to be shifted is set, and the specified cutting thickness is greater than the thickness corresponding to the specified number of copy sets to be shifted, the third control unit is configured to control the output position of the printed output sheets to be rotated every time the output sheets corresponding to the specified cutting thickness are printed or every time the output sheets corresponding to the specified number of copy sets to be shifted are printed,
wherein in a case where the rotation function for every specified cutting thickness is set, the rotation function for every specified number of copy sets to be shifted is set, and the specified cutting thickness is not greater than the thickness corresponding to the specified number of copy sets to be shifted, the fourth control unit is configured to control the output position of the printed output sheets to be rotated every time the output sheets corresponding to the specified number of copy sets to be shifted are printed, and
wherein in a case where neither the rotation function for every specified cutting thickness nor the rotation function for every specified number of copy sets to be shifted is set, the fifth control unit controls the output sheet to be printed without rotating the output position of the printed output sheets.

6. The image forming apparatus according to claim 1, wherein each of the first to fifth control units is configured to control printing so that data about a document scanned by a scanner is printed on the output sheet.

7. The image forming apparatus according to claim 1, wherein each of the first to fifth control units is configured to control printing so that data about a received document is printed on the output sheet.

8. The image forming apparatus according to claim 1, wherein each of the first to fifth control units is configured to control printing so that data about a document constituting one page is printed on each page of the output sheets.

9. The image forming apparatus according to claim 1, wherein each of the first to fifth control units is configured to control printing so that data about a document constituting a plurality of pages is printed on each page of the output sheets.

10. The image forming apparatus according to claim 1, wherein the at least one processor further operates as:
a first setting unit configured to set the shift function or the rotation function for every specified number of sheets to be cut or every specified cutting thickness; and
a second setting unit configured to set the shift function or the rotation function for every specified number of copy sets to be shifted.

11. A method for controlling an image forming apparatus, the method comprising:
controlling, as a first control, an output position of printed output sheets to be shifted or rotated every time output sheets corresponding to a specified number of sheets to be cut or a specified cutting thickness are printed in a case where a shift function or a rotation function for every specified number of sheets to be cut or every specified cutting thickness is set and a shift function or a rotation function for every specified number of copy sets to be shifted is not set;
controlling, as a second control, an output position of printed output sheets to be shifted or rotated every time output sheets corresponding to a specified number of copy sets to be shifted are printed in a case where the shift function or the rotation function for every specified number of copy sets to be shifted is set and the shift function or the rotation function for every specified number of sheets to be cut or every specified cutting thickness is not set;
controlling, as a third control, an output position of printed output sheets to be shifted or rotated every time output sheets corresponding to the specified number of sheets to be cut or the specified cutting thickness are printed or every time output sheets corresponding to the specified number of copy sets to be shifted are printed in a case where the shift function or the rotation function for every specified number of sheets to be cut or every specified cutting thickness is set, the shift function and the rotation function for every specified number of copy sets to be shifted is set, and the specified number of sheets to be cut or the specified cutting thickness is greater than the number of sheets corresponding to the specified number of copy sets to be shifted or a thickness corresponding to the specified number of copy sets to be shifted, respectively,
controlling, as a fourth control, an output position of printed output sheets to be shifted or rotated every time output sheets corresponding to the specified number of copy sets to be shifted are printed in a case where the shift function or the rotation function for every specified number of sheets to be cut or every specified cutting thickness is set, the shift function or the rotation function for every specified number of copy sets to be shifted is set, and the specified number of sheets to be cut or the specified cutting thickness is not greater than the number of sheets corresponding to the specified number of copy sets to be shifted or the thickness corresponding to the specified number of copy sets to be shifted, respectively; and
controlling, as a fifth control, an output sheet to be printed without shifting or rotating an output position of the printed output sheets in a case where neither the shift function or the rotation function for every specified number of sheets to be cut or every specified cutting thickness nor the shift function or the rotation function for every specified number of copy sets to be shifted is set.

12. A non-transitory computer readable storage medium storing a program for causing an information processing apparatus to perform a method, the method comprising:
controlling, as a first control, an output position of printed output sheets to be shifted or rotated every time output sheets corresponding to a specified number of sheets to be cut or a specified cutting thickness are printed in a case where a shift function or a rotation function for every specified number of sheets to be cut or every specified cutting thickness is set and a shift function or a rotation function for every specified number of copy sets to be shifted is not set;
controlling, as a second control, an output position of printed output sheets to be shifted or rotated every time output sheets corresponding to a specified number of copy sets to be shifted are printed in a case where the shift function or the rotation function for every specified number of copy sets to be shifted is set and the shift function or the rotation function for every specified number of sheets to be cut or every specified cutting thickness is not set;
controlling, as a third control, an output position of printed output sheets to be shifted or rotated every time output sheets corresponding to the specified number of sheets to be cut or the specified cutting thickness are printed or every time output sheets corresponding to the specified number of copy sets to be shifted are printed in a case where the shift function or the rotation function for every specified number of sheets to be cut or every specified cutting thickness is set, the shift function and the rotation function for every specified number of copy sets to be shifted is set, and the specified number of sheets to be cut or the specified cutting thickness is greater than a number of sheets corresponding to the specified number of copy sets to be shifted or a thickness corresponding to the specified number of copy sets to be shifted, respectively,
controlling, as a fourth control, an output position of printed output sheets to be shifted or rotated every time output sheets corresponding to the specified number of copy sets to be shifted are printed in a case where the shift function or the rotation function for every specified number of sheets to be cut or every specified cutting thickness is set, the shift function or the rotation function for every specified number of copy sets to be shifted is set, and the specified number of sheets to be cut or the specified cutting thickness is not greater than the number of sheets corresponding to the specified number of copy sets to be shifted or the thickness corresponding to the specified number of copy sets to be shifted, respectively; and
controlling, as a fifth control, an output sheet to be printed without shifting or rotating an output position of the printed output sheets in a case where neither the shift function or the rotation function for every specified number of sheets to be cut or every specified cutting thickness nor the shift function or the rotation function for every specified number of copy sets to be shifted is set.
